(19) United States
(12) Patent Application Publication
(10) Pub. No.: US 2017/0352470 A1
(43) Pub. Date: Dec. 7, 2017

(54) TRANSFORMER

(71) Applicants: Masahiro Yamagami, Aichi (JP); Noriyoshi Omote, Aichi (JP); Tomoyuki Hakata, Kyoto (JP); Masaya Fukuda, Kyoto (JP); Akio Sumiya, Shiga (JP)

(72) Inventors: Masahiro Yamagami, Aichi (JP); Noriyoshi Omote, Aichi (JP); Tomoyuki Hakata, Kyoto (JP); Masaya Fukuda, Kyoto (JP); Akio Sumiya, Shiga (JP)

(73) Assignees: OMRON AUTOMOTIVE ELECTRONICS CO., LTD., Aichi (JP); OMRON Corporation, Kyoto-shi (JP)

(21) Appl. No.: 15/455,205

(22) Filed: Mar. 10, 2017

(30) Foreign Application Priority Data
Jun. 6, 2016 (JP) 2016-112649

(51) Int. Cl. H01F 27/28; H01F 27/34

(52) U.S. Cl. CPC H01F 27/2804; H01F 27/346; H01F 2027/2809

(57) ABSTRACT

A transformer includes a stacked structure in which a plurality of coils is stacked through insulation layers. The stacked structure includes: a primary coil stacked layer including a plurality of primary coil layers connected in parallel with one another; and a secondary coil stacked layer including a plurality of secondary coil layers connected in parallel with one another. One of the primary coil layers is disposed as an outermost layer in the stacked structure, and another is disposed between at least two layers of the plurality of secondary coil layers. The primary coil layer includes a plurality of primary coils connected in parallel with one another. The secondary coil layer includes one or more secondary coils thicker than the primary coil.

### CROSS-REFERENCES TO RELATED APPLICATIONS

This application is based upon and claims the benefit of priority from Japanese Patent Application No. 2016-112649, filed on Jun. 6, 2016, the entire contents of which are incorporated herein by reference.

### FIELD

One or more embodiments of the present invention relate to a transformer, and specifically a stacked transformer in which a plurality of coils formed by layered conductors having a planar shape is stacked through insulator layers.

### BACKGROUND

In the related art, a stacked transformer which is formed in a planar shape on a printed circuit board and in which coil layers of a conductor are stacked as multi layers, is known. For example, JP-A-2013-247155 discloses a stacked transformer for decreasing leakage inductance without increasing cost. The stacked transformer may constitute a DC-DC converter, a primary coil layer and a secondary coil layer including a layered conductor of which the planar shape is formed in an annular shape, are stacked in a vertical direction through insulators. In the stacked transformer, a plurality of primary coil layers and a plurality of secondary coil layers are connected to each other in the vertical direction such that a primary coil and a secondary coil are formed. The primary coil includes the primary coil layer disposed in each of the uppermost layer and the lowermost layer of a stacked structure, and the secondary coil has a center tap and is divided into two sets of coils. Furthermore, one set of the secondary coil is formed by the secondary coil layers with a predetermined layer number of layers continuously formed in the vertical direction, and two sets of the secondary coil layers are disposed to face each other by interposing at least one layer or more of the primary coil layers therebetween.

In addition, in JP-A-H05-258977, a planar shape transformer, is disclosed, in which stray capacitance between adjacent spiral shape coil conductors decreases such that high frequency characteristics are improved. The planar shape transformer includes a lower first magnetic layer, a primary coil conductor and a secondary coil conductor being stacked in a spiral shape through an insulator layer on the lower first magnetic layer, and a second magnetic layer being disposed through the insulator layer on the stacked structure. In the planar shape transformer, the thickness of a conductor layer of the primary coil conductor is formed thinner than the thickness of the conductor layer of the secondary coil conductor.

In addition, JP-A-2008-004823 discloses a coil device in which a large current flows even if the number of the winding of a coil increases while using effectively a conductor pattern of the printed circuit board, and a manufacturing process is simplified while maintaining miniaturization. The coil device includes a primary side first coil part configured by electrically connecting between coil winding parts provided in each layer of a multilayer printed circuit board, and a primary side second coil part disposed to face the multilayer printed circuit board and electrically connected in series to the primary side first coil part.

In addition, JP-A-2005-045057 discloses a winding structure of a transformer which can easily obtain a predetermined inductance value by the transformer using leakage inductance. The winding structure is configured such that a primary winding to be wound around a core is divided into seven parts, a secondary winding to be wound is divided into two parts, a first part in which the divided primary winding and the divided secondary winding are alternately disposed therein, and a second part in which only the primary winding is disposed, and thus a ratio between the first part and the second part appropriately changes.

In addition, JP-A-2008-177486 discloses a transformer which can reduce loss at the time of operating the transformer. The transformer is configured by a primary side winding block formed by connecting in parallel one to a plurality of sets of winding parts in which at least two or more coil patterns are connected in series, and a secondary side winding block formed by connecting in parallel one to a plurality of sets of winding parts in which at least two or more coil patterns are connected in series, and electrically insulated from the primary side winding block. In addition, coil elements are stacked in the transformer so as to minimize as much as possible distances between at least one or more coil patterns in each of the entirety of the winding parts configuring the primary side winding block and at least one or more coil patterns in each of the entirety of the winding parts configuring the secondary side winding block.

### SUMMARY

One or more embodiments of the present invention provide a transformer which has decreased leakage inductance and is easily manufactured in small sizes.

In accordance with one or more embodiments of the present invention, there is provided a transformer including a stacked structure in which a plurality of coils is stacked through insulation layers, wherein the stacked structure includes: a primary coil stacked layer including a plurality of primary coil layers connected in parallel with one another, and a secondary coil stacked layer including a plurality of secondary coil layers connected in parallel with one another, wherein one of the primary coil layers is disposed as an outermost layer in the stacked structure, and another is disposed between at least two layers of the plurality of secondary coil layers, wherein the primary coil layer includes a plurality of primary coils connected in parallel with one another, and the secondary coil layer includes one or more secondary coils thicker than the primary coil.

With the above configuration, it is possible to provide the transformer in which leakage inductance decreases and which is easily manufactured in small sizes by thinning the primary coil to decrease resistance caused by skin effect, and by thickening a secondary coil to decrease the resistance.

The secondary coil layer may include a plurality of the secondary coils connected in parallel with one another, and a number of parallel connections of the primary coils in the primary coil layer may be equal to or greater than a number of parallel connections of the secondary coils in the secondary coil layer.

With the above configuration, since the number of parallel connections of the primary coil in the primary coil layer is set to be equal to or greater than the number of parallel connections of the secondary coil in the secondary coil layer, it is possible to further decrease the leakage inductance.

According to one or more embodiments of the present invention, it is possible to provide the transformer in which the leakage inductance decreases and which is easily manufactured in small sizes.

### BRIEF DESCRIPTION OF THE DRAWINGS

FIG. 1 is a schematic view of a vertical section of a transformer according to a first embodiment of the present invention;

FIG. 2 is a perspective view of the transformer (¼ fragment) according to the first embodiment of the present invention;

FIG. 3 is a schematic view of a vertical section showing a stacked structure of the transformer according to the first embodiment of the present invention;

FIG. 4 is a connection diagram of a primary coil stacked layer of the transformer according to the first embodiment of the present invention;

FIG. 5 is a connection diagram of a secondary coil stacked layer of the transformer according to the first embodiment of the present invention;

FIG. 6 is a schematic view of a vertical section of a transformer according to a second embodiment of the present invention;

FIG. 7 is a perspective view of the transformer (¼ fragment) according to the second embodiment of the present invention;

FIG. 8 is a schematic view of a vertical section showing a stacked structure of the transformer according to the second embodiment of the present invention;

FIG. 9 is a connection diagram of a primary coil stacked layer of the transformer according to the second embodiment of the present invention;

FIG. 10A is a schematic diagram showing a flow of a current in one layer within a primary coil of the transformer according to the second embodiment of the present invention;

FIG. 10B is a schematic diagram showing a flow of a current in two layers within the primary coil of the transformer according to the second embodiment of the present invention;

FIG. 11A is a plan view of a primary coil layer of the transformer according to the second embodiment of the present invention;

FIG. 11B is a front view of the primary coil layer of the transformer according to the second embodiment of the invention;

FIG. 11C is a side view of the primary coil layer of the transformer according to the second embodiment of the present invention;

FIG. 12 is a perspective view of the primary coil layer of the transformer according to the second embodiment of the present invention;

FIG. 13 is a connection diagram of a secondary coil stacked layer of the transformer according to the second embodiment of the present invention;

FIG. 14 is a schematic diagram showing a flow of a current in a secondary coil layer of the transformer according to the second embodiment according of the present invention;

FIG. 15A is a plan view of the secondary coil stacked layer of the transformer according to the second embodiment of the present invention;

FIG. 15B is a side view of the secondary coil stacked layer of the transformer according to the second embodiment of the present invention;

FIG. 15C is a sectional view (section taken along I-I in FIG. 15A) of the secondary coil stacked layer of the transformer according to the second embodiment according of the present invention; and

FIG. 16 is a perspective view of the secondary coil stacked layer of the transformer according to the second embodiment of the present invention.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

Hereinafter, embodiments of the present invention will be described with reference to the drawings.

### First Embodiment

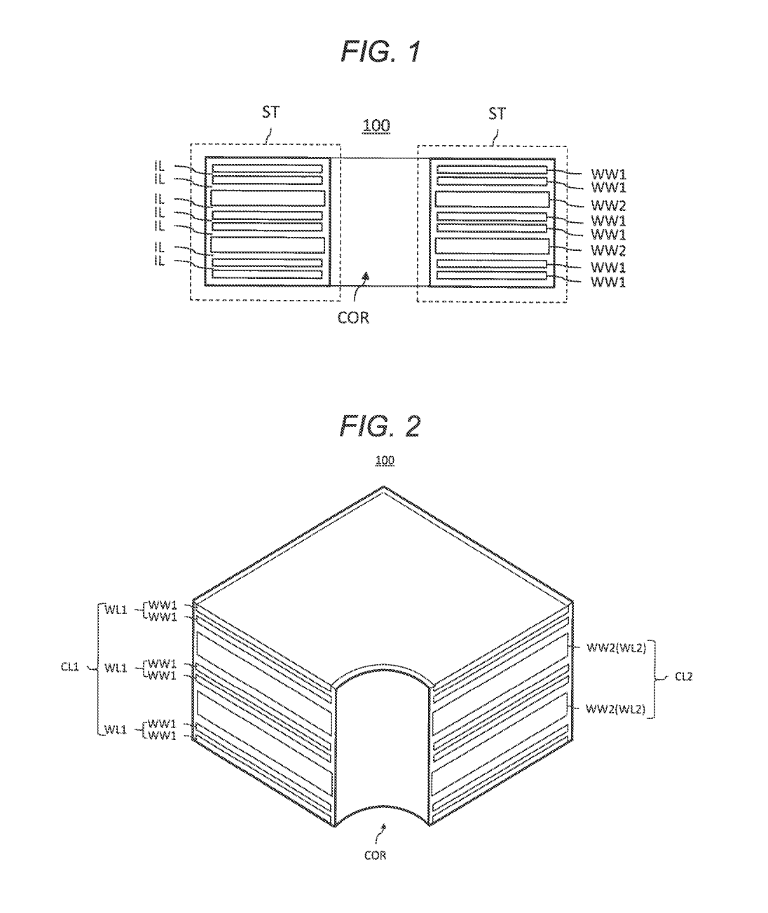

With reference to FIG. 1 to FIG. 5, a transformer 100 according to the embodiment will be described. The transformer 100 is used as a voltage conversion unit of one of electronic components such as a DC-DC converter (not shown) mounted on a front surface of a substrate (not shown). The transformer 100 may be mounted on the front surface of the substrate, and may be mounted as a part of a structure of the substrate by being formed as a wire formed on a surface layer and an inner layer of the substrate.

As shown in FIG. 1 to FIG. 3, the transformer 100 has a stacked structure ST in which a plurality of coils (primary coils WW1 and secondary coils WW2 described below) which is formed by layered conductors having a planar shape, is stacked with insulation layers IL formed by insulators interposed therebetween. In FIG. 1, a vertical section of the transformer 100, is shown, in a case where a stacked direction of the stacked structure ST is set as a longitudinal direction (vertical direction in the drawing), and the stacked structure ST configured by, annular coils (WW1 and WW2) and the insulation layers IL alternately stacked each other, is shown in both sides with a hollow part COR interposed therebetween. It is preferable to provide a ferrite core or the like through which magnetic force lines pass in the hollow part COR.

The coils in the stacked structure ST is roughly divided into the primary coils WW1 and the secondary coils WW2. The primary coils WW1 and the secondary coils WW2 are appropriately interlayer-connected therebetween as described below such that a primary coil layers WL1 and a primary coil stacked layer CL1 of a primary side, and a secondary coil layers WL2 and a secondary coil stacked layer CL2 of a secondary side are formed in the transformer 100. In the embodiment, two primary coils WW1 are stacked in a thickness direction (stacked direction) of the coil such that the primary coil layer WL1 is configured, and three primary coil layers WL1 are stacked in the thickness direction of the coil such that a primary coil stacked layer CL1 is configured.

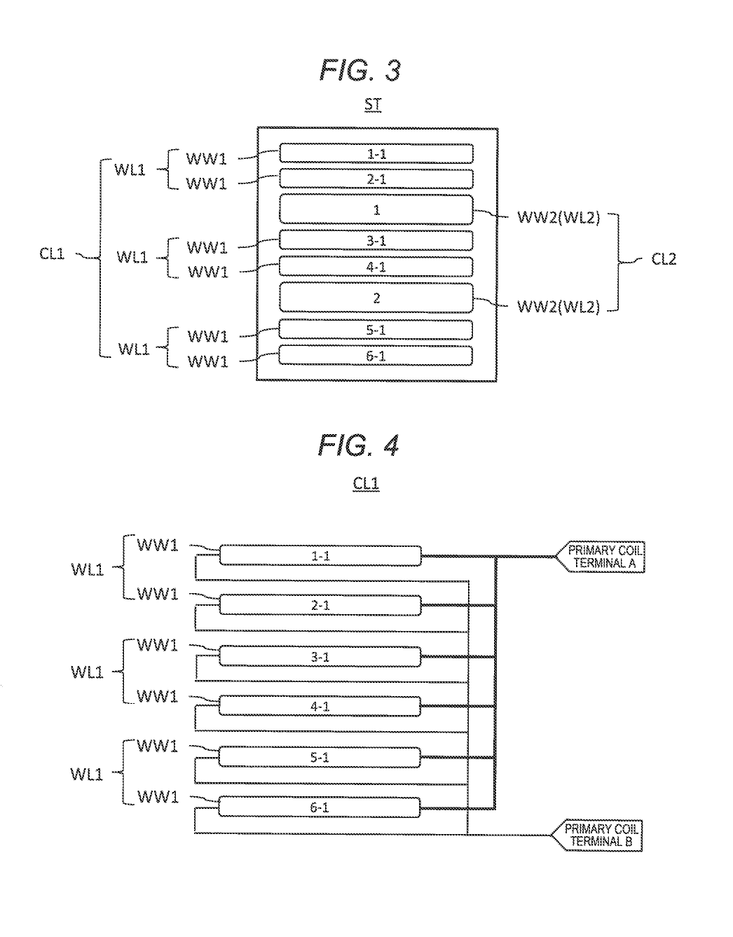

That is, as shown in FIG. 3, two layers of 1-1 and 2-1 that are the primary coils WW1 are stacked in the thickness direction of the coil such that the primary coil layer WL1 is configured, two layers of 3-1 and 4-1 that are the primary coils WW1 are stacked in the thickness direction of the coil such that the primary coil layer WL1 is configured, and two layers of 5-1 and 6-1 that are the primary coils WW1 are stacked in the thickness direction of the coil such that the primary coil layer WL1 is configured. In addition, two secondary coils WW2 are stacked in the thickness direction of the coil such that the secondary coil stacked layer CL2 is configured. That is, two layers of 1 and 2 that are the secondary coils WW2 are stacked in the thickness direction of the coil such that the secondary coil stacked layer CL2 is configured. In the embodiment, since it is possible to consider that the secondary coil layer WL2 is configured by one secondary coil WW2 for the secondary coil WW2, it can also be mentioned that the secondary coil stacked layer CL2 is configured by stacking two secondary coil layers WL2 in the thickness direction of the coil.

That is, the stacked structure ST is configured by the primary coil stacked layer CL1 and the secondary coil stacked layer CL2, the primary coil stacked layer CL1 is configured by three primary coil layers WL1, and the secondary coil stacked layer CL2 is configured by two secondary coil layers WL2 such that the stacked structure ST is configured by total five coil layers. The stacked structure ST is configured by alternately stacking total five coil layers of the primary coil layer WL1, the secondary coil layer WL2, the primary coil layer WL1, the secondary coil layer WL2, and the primary coil layer WL1 from the uppermost layer (or lowermost layer) in the stacked direction. Accordingly, the primary coil layer WL1 is disposed as the outermost layer (uppermost layer and lowermost layer in the drawing) in the stacked direction in the stacked structure ST.

In addition, the primary coil layer WL1 in the middle of the primary coil stacked layer CL1 is disposed between two layers of the secondary coil layer WL2. The embodiment is not limited to the configuration by total five coil layers of three primary coil layers WL1 and two secondary coil layers WL2. For example, the embodiment may be configured by total seven coil layers of four primary coil layers WL1 and three secondary coil layers WL2. Preferably, the structure is configured by N primary coil layers WL1 and N+1 secondary coil layers WL2 so that the primary coil layer WL1 is the outermost layer in the stacked structure ST in the stacked direction, and the primary coil layers WL1 and the secondary coil layers WL2 are alternately stacked.

In addition, as shown in FIG. 4, in the primary coil stacked layer CL1, each of the primary coils WW1 is directly connected to a primary coil terminal A and a primary coil terminal B to which AC power source is supplied, and the primary coils WW1 are connected in parallel with each other. That is, the primary coil stacked layer CL1 is configured by a plurality of primary coil layers WL1 and the primary coils WW1 connected in parallel with each other. In addition, the primary coil layers WL1 is configured by two primary coils WW1 that are connected in parallel with each other.

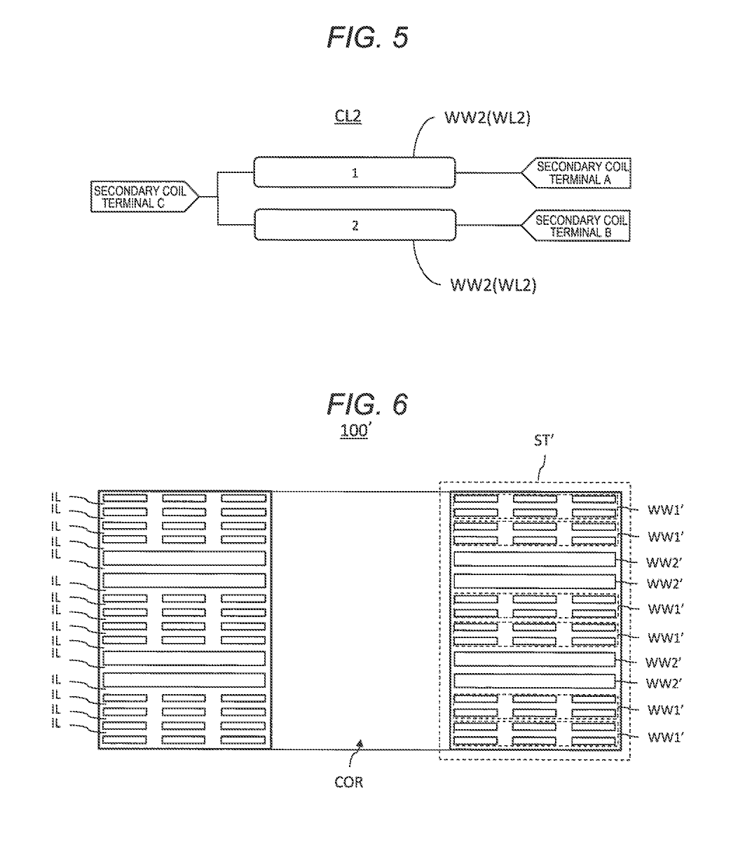

In addition, as shown in FIG. 5, in the secondary coil stacked layer CL2, each of the secondary coils WW2 is directly connected to a secondary coil terminal A or a secondary coil terminal B (for example, a terminal connected to a positive electrode of a battery), and a secondary coil terminal C (for example, a terminal connected to a negative electrode of a battery), and the secondary coils WW2 are connected in parallel with each other. That is, the secondary coil stacked layer CL2 is configured by a plurality of secondary coil layers WL2 and the secondary coils WW2 that are connected in parallel with each other.

In addition, as shown in FIG. 1 to FIG. 3, the secondary coil layer WL2 is configured by the secondary coil WW2 thicker than the primary coil WW1 in the stacked direction (in thickness direction of coil). Conversely, the thickness of the conductor in the primary coil WW1 configured by the layered conductors is thinner than that in the secondary coil WW2 configured by the layered conductors. In the voltage conversion unit such as the DC-DC converter, since an alternating current flows in the primary coil WW1 and a direct current flows in the secondary coil WW2, thereby the voltage conversion unit generates a predetermined voltage. In a case where the alternating current flows in the primary coil WW1, since the skin effect, is generated, in which the current density is high on a surface of the conductor and decreases when it is separated from the surface, and a current is concentrated on the surface as a frequency increases, an AC resistance of the entirety of the conductors increases. Accordingly, by decreasing the thickness of a section of a coil in the primary coil WW1 through which the alternating current flows, it is possible to decrease the AC resistance caused by the skin effect. Specifically, it is preferable that the primary coil WW1 is formed of a thin copper foil.

Meanwhile, since the direct current flows in the secondary coil WW2 and resistance decreases as the section area of a coil increases, it is possible to decrease the resistance by increasing the thickness of the section of the coil in the secondary coil WW2. Specifically, it is preferable that the secondary coil WW2 is formed by a material with a large thickness such as a copper plate. In this manner, since the secondary coil layer WL2 is configured by the secondary coil WW2 formed by the conductor thicker than the primary coil WW1 such that the resistance caused by the skin effect in the primary coil layer WL1 decreases. In addition, since the resistance is decreased by thickening the secondary coil WW2, it is possible to decrease the leakage inductance, and provide the transformer 100 which can be easily manufactured in small sizes.

### Second Embodiment

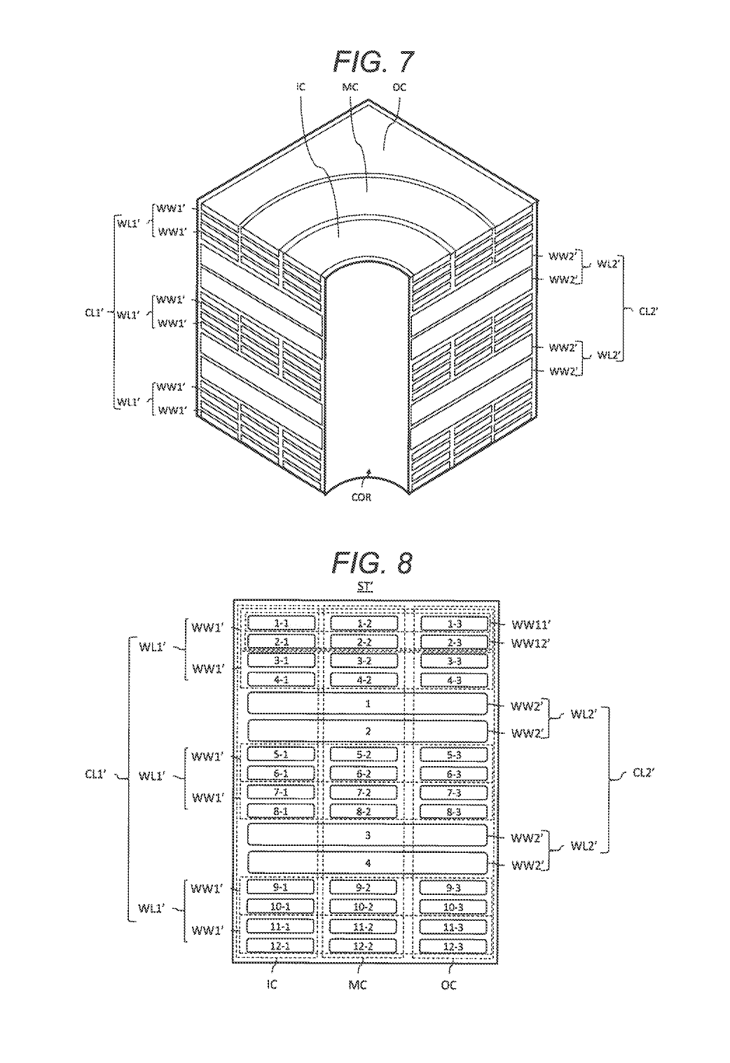

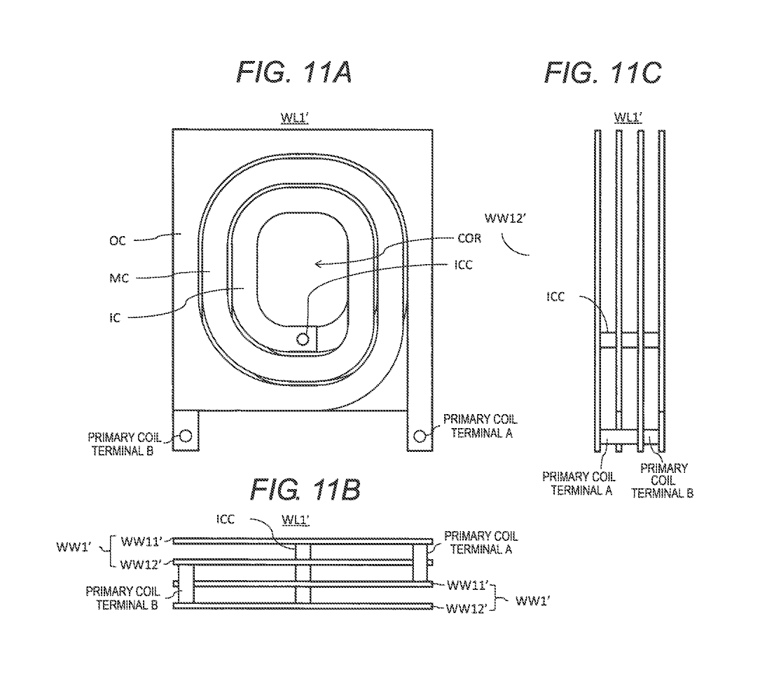

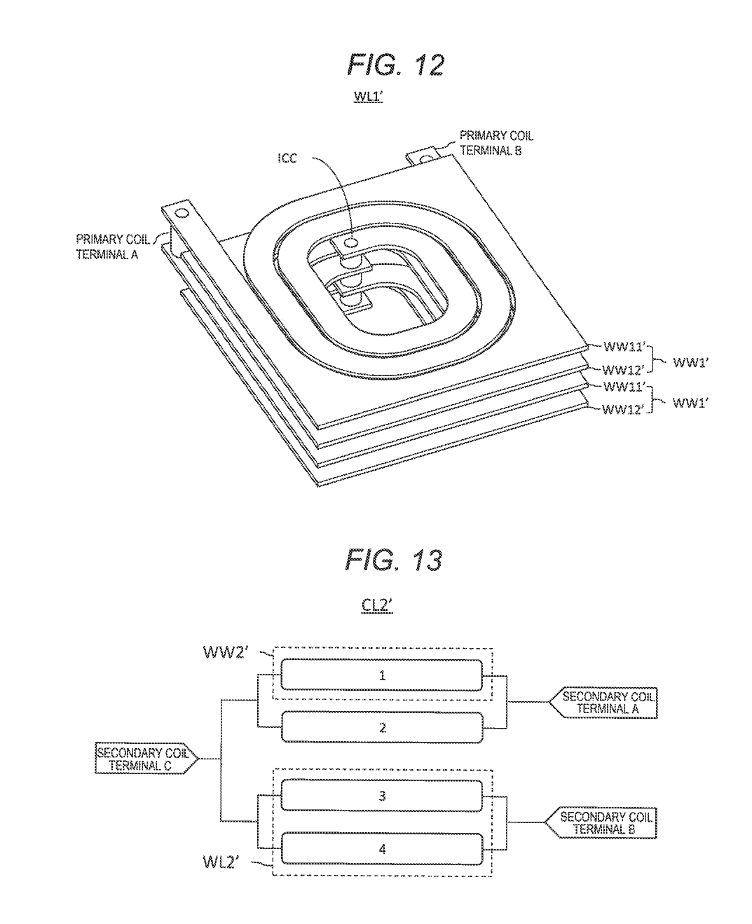

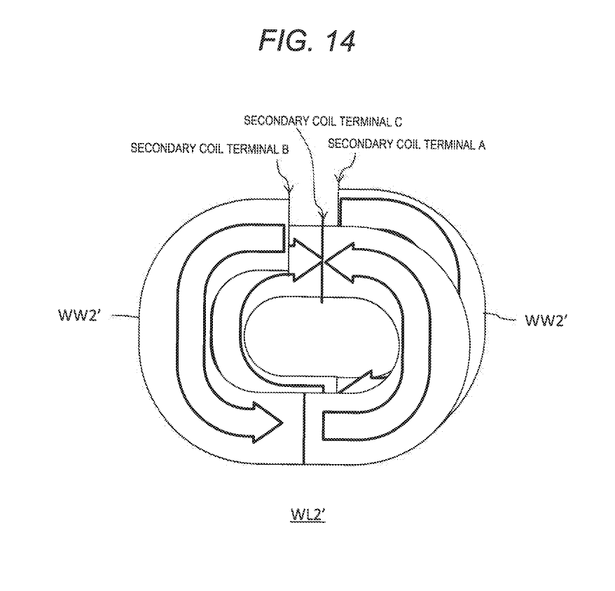

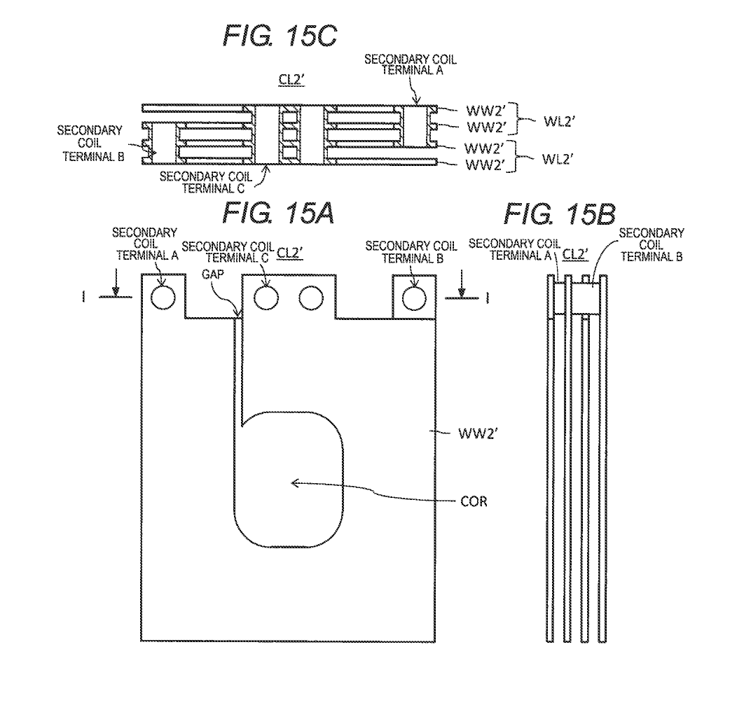

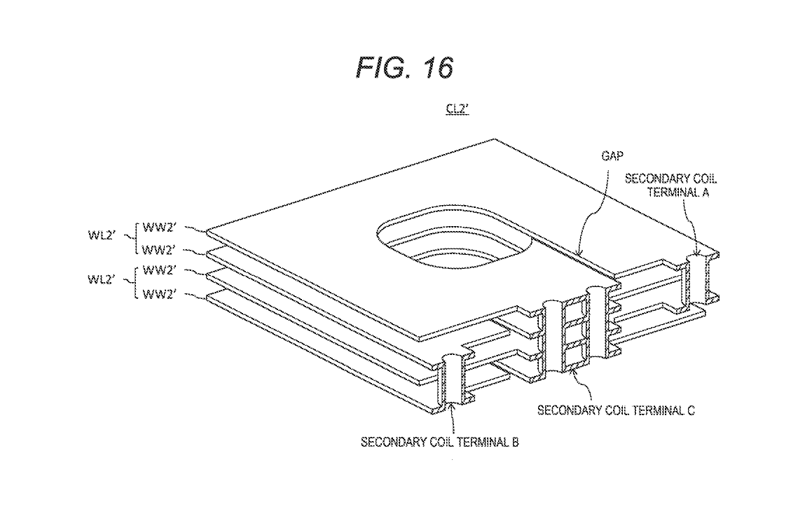

With reference to FIG. 6 to FIG. 16, a transformer 100′ in the embodiment will be described. In order to avoid redundant description, the same components are denoted by the same reference numerals and description thereof is omitted. The transformer 100′ is used as the voltage conversion unit of one of the electronic components such as the DC-DC converter (not shown). As shown in FIG. 6 to FIG. 8, the transformer 100′ has a stacked structure ST′ in which a plurality of coils (primary coils WW1′ and secondary coils WW2′ described below) which is formed by layered conductors having a planar shape is stacked with insulation layers IL formed by an insulator interposed therebetween.

The coils in the stacked structure ST′ is roughly divided into the primary coils WW1′ and the secondary coils WW2′. The primary coils WW1′ and the secondary coils WW2′ are appropriately interlayer-connected therebetween as described below such that a primary coil layers WL1′ and a primary coil stacked layer CL1′ of a primary side, and a secondary coil layers WL2′ and a secondary coil stacked layer CL2′ of a secondary side are formed in the transformer 100′. In the embodiment, two primary coils WW1′ are stacked in the thickness direction (stacked direction) of the coil such that the primary coil layer WL1′ is configured, and three primary coil layers WL1′ are stacked in the thickness direction of the coil such that a primary coil stacked layer CL1′ is configured.

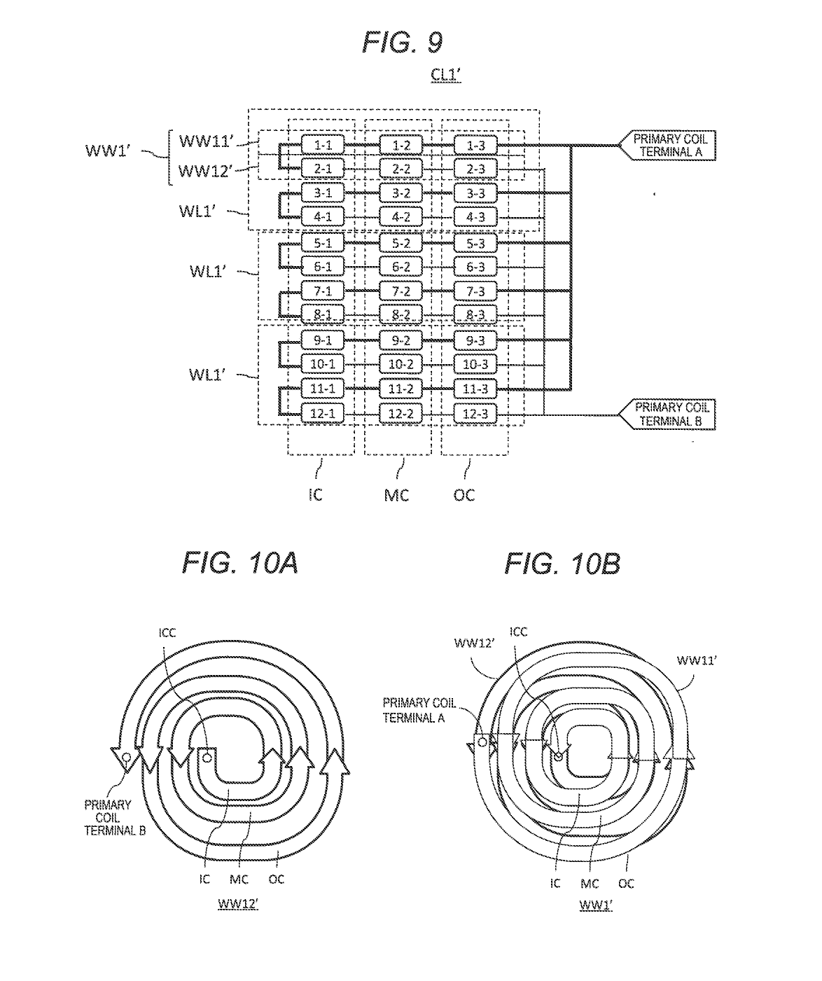

As shown in FIG. 9 to FIG. 10B, one primary coil WW1′ is configured in a spiral shape, and configured by connecting in series a first layer WW11′ within the primary coil including an inner coil IC, a middle coil MC, and an outer coil OC wound three times, with a second layer WW12′ within the primary coil by similarly including the inner coil IC, the middle coil MC, and the outer coil OC wound three times. More specifically, for example, the second layer WW12′ within the primary coil is implemented by winding the coil tree times as 2-1 that is the inner coil IC, 2-2 that is the middle coil MC, and 2-3 that is the outer coil OC, and connected to the primary coil terminal B at a terminal end of 2-3 of the outer coil OC. Similarly, for example, the first layer WW11′ within the primary coil is implemented by winding the coil three time as 1-1 that is the inner coil IC, 1-2 that is the middle coil MC, and 1-3 that is the outer coil OC, and connected to the primary coil terminal A at a terminal end of the outer coil OC 1-3. It is preferable that a ferrite core or the like is provided in the hollow part COR that is the center portion of the spiral shape.

2-1 of the inner coil IC of the second layer WW12′ within the primary coil and 1-1 of the inner coil IC of the first layer WW11′ within the primary coil are connected to each other at an inner coil connection part ICC. Accordingly, for example, a current that is input from the primary coil terminal B flows from 2-3 of the outer coil OC of the second layer WW12′ within the primary coil to the primary coil terminal A, through 2-2 of the middle coil MC of the second layer WW12′ within the primary coil, 2-1 of the inner coil IC of the second layer WW12′ within the primary coil, the inner coil connection part ICC, 1-1 of the inner coil IC of the first layer WW11′ within the primary coil, 1-2 of the middle coil MC of the first layer WW11′ within the primary coil, and 1-3 of the outer coil OC of the first layer WW11′ within the primary coil. That is, the first layer WW11′ within the primary coil and the second layer WW12′ within the primary coil are connected to each other in series. In this manner, since one primary coil WW1′ is divided into two layers and the two layers are connected to each other in series such that the section of the coil in the primary coil WW1′ is further thinned, it is possible to decrease the AC resistance caused by the skin effect.

As shown in FIG. 8 and FIG. 9 and FIG. 11A to FIG. 12, two primary coils WW1′ implemented by the first layer WW11′ within the primary coil and the second layer WW12′ within the primary coil are stacked in the thickness direction of the coil and connected in parallel with each other such that the primary coil layer WL1′ is configured. For example, the primary coil WW1′ including the first layer WW11′ within the primary coil implemented by winding the coil three times as 1-1 of the inner coil IC, 1-2 of the middle coil MC, and 1-3 of the outer coil OC and the second layer WW12′ within the primary coil implemented by winding the coil three times as 2-1 of the inner coil IC, 2-2 of the middle coil MC, and 2-3 of the outer coil OC and the primary coil WW1′ including the first layer WW11′ within the primary coil implemented by winding the coil three times as 3-1 of the inner coil IC, 3-2 of the middle coil MC, and 3-3 of the outer coil OC and the second layer WW12′ within the primary coil implemented by winding the coil three times as 4-1 of the inner coil IC, 4-2 of the middle coil MC, and 4-3 of the outer coil OC, are connected in parallel with each other such that the primary coil layer WL1′ is configured. More specifically, each terminal end of the outer coils OC (for example, 1-3 and 3-3) of each of the first layer WW11′ within the primary coil is connected to the primary coil terminal A, and each terminal end of the outer coils OC (for example, 2-3 and 4-3) of each of the second layer WW12′ within the primary coil is connected to the primary coil terminal B.

As described above, three primary coil layers WL1′ are stacked in the thickness direction of the coil, and connected in parallel with each other such that the primary coil stacked layer CL1′ is configured. Meanwhile, in the secondary coil stacked layer CL2′, two secondary coils WW2′ are stacked in the thickness direction (stacked direction) of the coil such that the secondary coil layer WL2′ is configured, and two secondary coil layers WL2′ are stacked in the thickness direction of the coil such that the secondary coil stacked layer CL2′ is configured.

For example, as shown in FIG. 13 to FIG. 16, one secondary coil WW2′ is configured by a coil 1 that is wound one time. More specifically, for example, in the secondary coil WW2′, one end of the coil 1 is connected to the secondary coil terminal A, and the other end thereof in which a gap is formed is connected to the secondary coil terminal C. In addition, in a coil 2 that is stacked with the coil 1 that is the secondary coil WW2′ in the thickness direction of the coil and connected in parallel with the coil 1, one end thereof is connected to the secondary coil terminal A, and the other end in which a gap is formed is connected to the secondary coil terminal C. Accordingly, the coils 1 and 2 that are the secondary coils WW2′ are stacked each other such that the secondary coil layer WL2′ is configured.

In addition, in the other secondary coil layer WL2′ in the secondary coil stacked layer CL2′, coils 3 and 4 that are the secondary coils WW2′ are stacked, and one end of the coil 3 that is the secondary coil WW2′ is connected to the secondary coil terminal B, the other end thereof in which a gap is formed is connected to the secondary coil terminal C, and one end of the coil 4 that is stacked with the coil 3 that is the secondary coil WW2′ in the thickness direction of the coil and connected in parallel with the coil 3, is connected to the secondary coil terminal B, and the other end thereof in which a gap is formed, is connected to the secondary coil terminal C.

Two secondary coils WW2′ configuring the secondary coil layer WL2′ are connected to each other at the secondary coil terminal C. Accordingly, for example, a current that is input from the secondary coil terminal A and the secondary coil terminal B flows to the secondary coil terminal C through the secondary coil WW2′. That is, two secondary coils WW2′ in the secondary coil layer WL2′ are connected in parallel with each other, and two secondary coil layers WL2′ in the secondary coil stacked layer CL2′ are connected in parallel with each other.

The stacked structure ST′ is implemented by the primary coil stacked layer CL1′ and the secondary coil stacked layer CL2′, the primary coil stacked layer CL1′ is configured by three primary coil layers WL1′, and the secondary coil stacked layer CL2′ is configured by two secondary coil layers WL2′. Accordingly, the stacked structure ST′ is configured by total five coil layers. The stacked structure ST′ is implemented by alternately stacking total five coil layers from the uppermost layer (or lowermost layer) in the stacked direction, the primary coil layer WL1′, the secondary coil layer WL2′, the primary coil layer WL1′, the secondary coil layer WL2′, and the primary coil layer WL1′. Accordingly, the primary coil layer WL1′ is disposed as the outermost layer (uppermost layer and lowermost layer in the drawing) in the stacked direction in the stacked structure ST′. In addition, the center primary coil layer WL1′ in the middle of the primary coil stacked layer CL1′ is disposed between the two secondary coil layers WL2′.

In addition, as shown in FIG. 9, in the primary coil stacked layer CL1′, the primary coils WW1′ are directly connected to the primary coil terminal A and the primary coil terminal B to which the AC power source is supplied, and connected in parallel with each other. That is, the primary coil stacked layer CL1′ is configured by a plurality of primary coil layers WL1′ and the primary coils WW1′ that are connected in parallel with each other. In addition, the primary coil layers WL1′ are configured by the two primary coils WW1′ that are connected in parallel with each other.

In addition, as shown in FIG. 13, in the secondary coil stacked layer CL2′, the secondary coils WW2′ are directly connected to the secondary coil terminal A or the secondary coil terminal B, and to the secondary coil terminal C, and connected in parallel with each other. That is, the secondary coil stacked layer CL2′ is configured by a plurality of secondary coil layers WL2′ that is connected in parallel with each other, and the secondary coil layer WL2′ is configured by a plurality of the secondary coils WW2′.

In addition, as shown in FIG. 6 to FIG. 8, the secondary coil layer WL2′ is configured by the secondary coil WW2′ thicker than the primary coil WW1′ in the stacked direction (in thickness direction of coil). In other words, the thickness of the conductor of the primary coil WW1′ implemented by the layered conductors is thinner than that of the secondary coil WW2′ implemented by the layered conductors. With this, it is possible to decrease the AC resistance caused by the skin effect in the primary side. Meanwhile, in the secondary coil WW2′, since resistance decreases as the section area of the coil increases, it is possible to decrease the resistance of the secondary coil WW2′ by increasing the section of the coil. In this manner, since the secondary coil layer WL2′ is configured by the secondary coil WW2′ formed by the conductor thicker than the primary coil WW1′, by decreasing the resistance caused by the skin effect in the primary coil layer WL1′ and by decreasing the resistance by thickening the secondary coil WW2′, it is possible to provide a transformer 100′ which decreases the leakage inductance and is easy to manufacture in small sizes.

In addition, as the number of the primary coils WW1′ connected in parallel in the primary coil layer WL1′ is two, and the number of the secondary coils WW2′ connected in parallel in the secondary coil layer WL2′ is two, that is, the numbers of the coils WW1′ and WW2′ are the same. However, it is preferable that the number of parallel connections of the primary coils WW1′ in the primary coil layer is set to be equal to or greater than the number of parallel connections of the secondary coils WW2′ in the secondary coil layer. By doing so, since it is possible to further thin the primary coil, it is possible to further decrease the leakage inductance.

While the invention has been described with respect to a limited number of embodiments, those skilled in the art, having benefit of this disclosure, will appreciate that other embodiments can be devised which do not depart from the scope of the invention as disclosed herein. According, the scope of the invention should be limited only by the attached claims.

1. A transformer comprising:
a stacked structure in which a plurality of coils is stacked through insulation layers,
wherein the stacked structure comprises:
a primary coil stacked layer comprising a plurality of primary coil layers connected in parallel with one another; and
a secondary coil stacked layer comprising a plurality of secondary coil layers connected in parallel with one another,
wherein one of the primary coil layers is disposed as an outermost layer in the stacked structure, and another is disposed between at least two layers of the plurality of secondary coil layers,
wherein the primary coil layer comprises a plurality of primary coils connected in parallel with one another, and
wherein the secondary coil layer comprises one or more secondary coils thicker than the primary coil.

2. The transformer according to claim 1,
wherein the secondary coil layer comprises a plurality of the secondary coils connected in parallel with one another, and
wherein a number of parallel connections of the primary coils in the primary coil layer is equal to or greater than a number of parallel connections of the secondary coils in the secondary coil layer.
